(19) United States
(12) Patent Application Publication
(10) Pub. No.: US 2009/0174629 A1
(43) Pub. Date: Jul. 9, 2009

(54) Organic Light Emitting Display Device and driving method thereof

(76) Inventor: Dong-Woo Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/230,946

(22) Filed: Sep. 8, 2008

(30) Foreign Application Priority Data
Jan. 3, 2008 (KR) 10-2008-0000734

(51) Int. Cl. G09G 3/30

(52) U.S. Cl. 345/76

(57) ABSTRACT

A circuit and process capable of smoothly switching between screens of an organic light emitting display by switching an image of a pixel unit that includes a matrix of pixels into a black image by sequentially reducing the voltage of a first power supply at least two times to display the black image as the screen of the pixel unit transitions to the black image.

### CLAIM OF PRIORITY

This application makes reference to, incorporates the same herein, and claims all benefits accruing under 35 U.S.C. §119 from an application for ORGANIC LIGHT EMITTING DISPLAY AND DRIVING METHOD THEREOF earlier filed in the Korean Intellectual Property Office on the 3, Jan. 2008, and there duly assigned Serial No. 10-2008-0000734.

### BACKGROUND OF THE INVENTION

1. Field of the Invention

The present invention relates to an organic light emitting display device and a driving method therefor, and, more particularly, to an organic light emitting display and to a method for driving an organic light emitting display device to smoothly switch screens of the display.

2. Description of the Related Art

Recently developed flat panel display devices that are capable of reducing weight and overall volume, tend to suffer from some of the disadvantages of display devices that use cathode ray tubes. Such recent flat panel display devices include, among other types, liquid crystal displays (LCD), field emission displays (FED), plasma display panels (PDP) and organic light emitting displays (OLED).

Organic light emitting display devices display visual images by using a matrix of organic light emitting diodes, each of which is capable of generating light through the recombination of electrons and holes. Organic light emitting diodes have the advantage of being able to be driven with low power consumption, and have a rapid response speed.

Empirically, organic light emitting display devices are constructed with a pixel unit formed by a plurality of pixels, drive circuits that supply driving signals to the pixel unit, and a power source that supplies electrical power to the pixel unit.

The pixels emit light with a brightness that corresponds to the data signals applied to the display device in synchronization with scan signals applied to the display device. The brightness of the emissions of the pixels in an organic light emitting display device is affected by the voltage of the pixel power sources. That is, the data signals and the power provided by the power source determines the emission brightness of the pixels. Organic light emitting display devices display visual images by arranging the plurality of pixels in a type of matrix. Organic light emitting display devices control the amount of electrical current flowing from a first power supply to a second power supply via corresponding organic light emitting diodes, and the images displayed by those pixels have a predetermined gray scale.

In order to prevent a panel from continuously displaying a single, unvarying image for a prolonged period of time, such an organic light emitting display device is switched into a sleep mode (for example, a mode of operation of the display device where the screen of the display device continuously displays black across the entire screen) in the case where there is no input of data signals from a user for a predetermined time. In organic light emitting display devices in contemporary art however, because the brightness must be abruptly changed when the display device is switched into the sleep mode from, for example, a mode during which the display device presents a single, constant visual image to a viewing audience, noise causes the video images to be shaped by the noise and to be displayed on the screen of the display device in lieu of the completely black screen that is characteristic of the sleep mode. In the same manner, organic light emitting display devices in the contemporary practice of the art have a problem when the brightness is abruptly changed due to the electrical power being turned off.

### SUMMARY OF THE INVENTION

Therefore, it is an object of the present invention to provide an improved organic light emitting display device and an improved method for driving organic light emitting display devices.

It is another object to provide an organic light emitting display device and a method for driving organic light emitting display devices which is capable of smoothly switching between the screens of the display device.

In order to accomplish these and other objects, one embodiment of the present invention includes among the steps of a method for driving an organic light emitting display device, the steps of switching an image formed by a pixel unit that includes multiple pixels, to a black image; and sequentially dropping the magnitude of the voltage from a first power supply at least two times so as to be able to continuously display a completely black screen (i.e., a black image) after the display device has been switched into the sleep mode.

Exemplarily, the step of switching to the black image includes the steps of switching into a sleep mode and turning off the application of electrical power, because an input signal may not be applied to the display device for a indeterminate period of time.

There is provided an organic light emitting display device constructed as an embodiment of the present invention that includes a pixel unit positioned in an intersection part of scan lines and data lines, and includes pixels controlling the amount of current flowing from a first power supply to a second power supply via an organic light emitting diode; a timing controller generating screen switching signals when an image displayed on the pixel unit is switched to a black image; a voltage controller sequentially generating a plurality of level signals when the screen switching signals are input; and a first power supply generating unit sequentially dropping the voltage of the first power supply whenever the level signals are input.

Exemplarily, the timing controller generates the screen switching signals for the sleep mode and for turning off application of electrical power when input from the external is has not been made for a predetermined time. The first power supply generating unit drops [the magnitude of???] the voltage of the first power supply until a black image is displayed on the pixel unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a schematic block diagram showing an organic light emitting display constructed as an embodiment of the present invention;

FIG. 2 is a flow chart showing an operational process that may be followed by the voltage controller and the first power supply generating unit of FIG. 1 during the practice of the principles of this invention; and

FIG. 3 is a two-coordinate Cartesian graph showing along its ordinate units of brightness of a screen measured in units of candela per square meter and the amount of current in, units of milli-Amperes, flowing through an organic light emitting diode, corresponding to the voltage applied across the pixels.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity in order to avoid obscuring the principles of the present invention. Also, like reference numerals refer to like elements throughout.

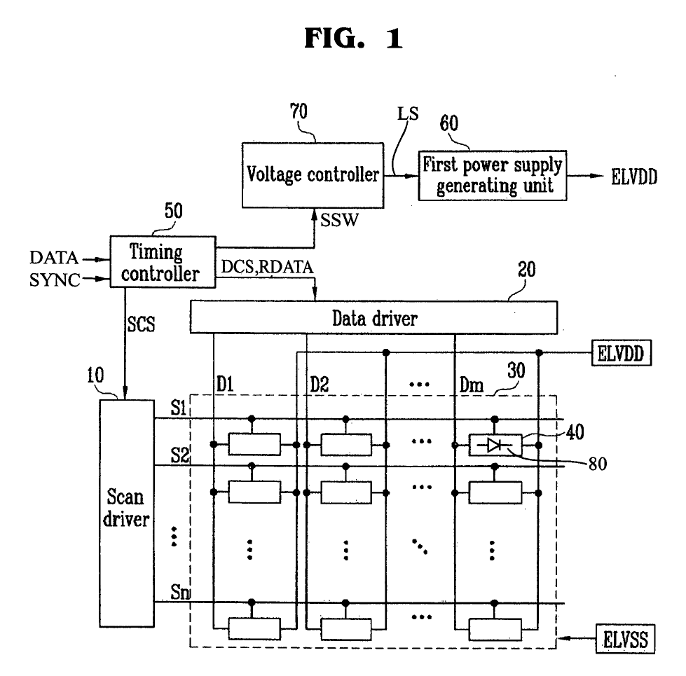

Hereinafter, exemplary embodiments of the present invention that those skilled in the art to which the present invention pertains can easily carry out will be described with reference to FIGS. 1 through 3, collectively.

FIG. 1 is a schematic block diagram showing an organic light emitting display constructed as an embodiment of the present invention.

Referring to FIG. 1, an organic light emitting display constructed as an embodiment of the present invention includes a pixel unit 30, a scan driver 10, a data driver 20, a timing controller 50, a first power supply generating unit 60, and a voltage controller 70.

The pixel unit 30 includes a plurality of pixels 40 coupled to scan lines S1 through Sn, and to data lines D1 through Dm. Pixel unit 30 applies a first voltage provided by a first power supply ELVDD supplied from a first power generating unit 60 and a second voltage provided by a second power supply ELVSS from an external source, to pixels 40. Pixels 40, supplied by first power supply ELVDD and second power supply ELVSS, apply the potential difference between ELVDD and ELVSS across organic light emitting diodes 80 when selected scan signals are applied, then organic light emitting diodes 80 emit light with a brightness corresponding to the data signals DATA applied.

To this end, pixels 40 include an organic light emitting diode (not shown) and a pixel circuit for supplying current to the organic light emitting diode 80. The pixel circuit includes at least two transistors and capacitors. Such a pixel circuit controls the amount of electrical current supplied from the first power supply ELVDD to the second power supply ELVSS via the organic light emitting diodes, in correspondence with the data signals. The organic light emitting diode emits light of red, green, or blue, in correspondence with the amount of electrical current supplied to the pixel circuit.

Meanwhile, although FIG. 1 illustrates a design with pixel 40 coupled to one scan line and one data line for convenience of explanation, the practice of the principles of the present invention is not limited thereto. For one example, the constitution of the pixel circuit included in pixel 40 may be established in various designs currently well-known and, in this case, two or more scan lines and two or more light emitting control lines (not shown) may also be coupled to the pixel 40, depending upon the particulars of the constitution of the pixel circuit.

Scan driver 10 drive scan lines S1 through Sn by sequentially supplying scan signals to the scan lines S1 through Sn. When the scan signals are sequentially supplied to the scan lines S1 through Sn, corresponding pixels 40 are sequentially selected by the line unit.

Data driver 20 drives data lines D1 to Dm. More specifically, data driver 20 generates the data signals using the data supplied from the timing controller 50, and supplies the data signals generated and applied to data lines D1 through Dm whenever the scan signals are supplied. Then, the data signals are applied to those pixels 40 selected by means of the scan signals.

Timing controller 50 generates data driving control signals DCS, and scan driving control signals SCS, in correspondence to synchronization signals SYNC supplied from the external source. The data driving control signals DCS generated by timing controller 50 are supplied to data driver 20, and the scan driving control signals SCS generated by timing controller 50 are supplied to scan driver 10. In such a manner, timing controller 50 controls scan driver 10 and data driver 20 in correspondence with the synchronization signals SYNC supplied from the external source. Also, timing controller 50 re-arranges the data signals DATA supplied from the external source to supply the rearranged data signals RDATA to data driver 20.

In the practice of the present invention however, timing controller 50 supplies screen switching signals SSW to voltage controller 70 when pixel unit 30 is switched to show a black screen. For example, in such instances as placing the display device into the sleep mode and turning off electrical power to the display device, timing controller 50 supplies screen switching signals SSW to voltage controller 70.

Power controller 70 controls a level (i.e., the amplitude) of voltage applied to pixel unit 30 by first power supply ELVDD generated from first power supply generating unit 60 in correspondence to the screen switching signals SSW supplied by timing controller 50. Voltage controller 70 sequentially supplies a plurality of level signals LS to first power supply generating unit 70 when screen switching signals SSW are supplied from the timing controller 50. Herein, voltage controller 70 may be included inside data driver 20 when data driver 20 is constructed as an integrated circuit. First power supply generating unit 60 generates the electrical power applied to first power supply ELVDD in correspondence to the level signals LS received from voltage controller 70. More specifically, first power supply generating unit 60 generates the voltage applied to pixels 40 by first power supply ELVDD with the voltage preset when the level signals LS are received by first power supply generating unit 60 from voltage controller 70, and first power supply generating unit 60 supplies the voltage applied to pixels 40 by first power supply ELVDD. Also, first power supply generating unit 60 sequentially reduces the amplitude of the voltage applied to pixels 40 by first power supply ELVDD whenever the level signals are input by voltage controller 70. For example, when level signals LS are input from voltage controller 70, by way of example, by three times in sequence, first power supply generating unit 60 sequentially reduces the voltage applied to pixels 40 incrementally by first power supply ELVDD three times in response.

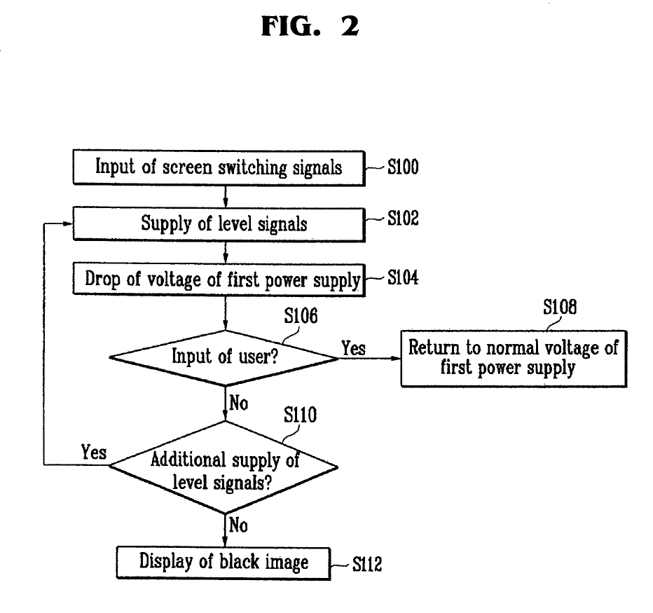

FIG. 2 is a flow chart showing an operating process that may be followed by voltage controller 70 and the power supply generating unit of FIG. 1.

Referring to FIG. 2, first when an image to be displayed by pixel unit 30 is switched to a black image, for example, upon the occasions of placing the display device into a sleep mode and turning off electrical power to the display device, timing controller 50 supplies screen switching signals SSW to voltage controller 70 in step S100.

Voltage controller 70 responds to reception of screen switching signals SSW in step S100 by generating level signals LS and by applying those level signals LS to first power supply generating unit 60 during step S102.

As first power supply generating unit 60 is supplied with level signals LS in step S102, in step S104, first power supply generating unit 60 reduces the voltage of the first power supply ELVDD by a predetermined voltage to supply the voltage of reduced amplitude to pixels 40.

Thereafter, when predetermined signals are input from a user, for example, when any signals are detected as being input by the user of the display device while the display device is in the process of being switched into the sleep mode, in step S106 timing controller 50 stops supplying screen switching signals. In this case, the generation of level signals LS by voltage controller 70 is interrupted, and in response to this interruption, and in step S108, first power supply generating unit 60 resumes application of the first power supply ELVDD having a normal amplitude of voltage to supply to pixels 40.

Alternatively however, when no input from the user is detected during step S106, in step S110 voltage controller 70 makes a determination of whether, or not, additional level signals LS should be supplied to first power supply generating unit.

If as a result of the determination in step S110, additional the level signals are then supplied in step S102, as steps S102 to 5110 are repeated. If, as a result of the determination made in step S110, additional the level signals are not supplied as a result of the determination made in step S110, that is, if the voltage of the first power supply ELVDD has already been sufficiently reduced to an amplitude of the voltage for displaying a black image, a black screen is displayed on the pixel 30 (S112).

Meanwhile, voltage controller 70 supplies level signals LS to first power supply generating unit 60 at least two or more times in order that the voltage of the first power supply ELVDD will not be not abruptly dropped. As a consequence, the voltage of the first power supply ELVDD is incrementally dropped at least two or more times.

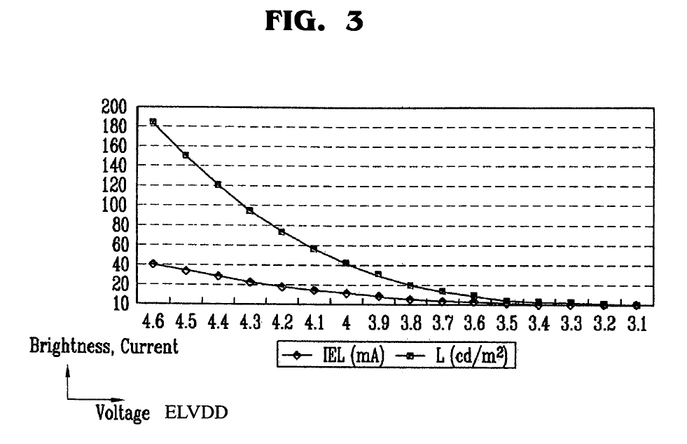

FIG. 3 is a two coordinate Cartesian graph showing on its ordinate the brightness of a display device as a function of the amplitude of voltage ELVDD applied by a first power supply to pixels 40 and the amount of current flowing in an organic light emitting diode. Table 1 is obtained from the graph of FIG. 3.

TABLE 1

| ELVDD | IEL (mA) | L (Cd/m2) |
|---|---|---|
| 4.6 | 40 | 184 |
| 4.5 | 34 | 150 |
| 4.4 | 28 | 121 |
| 4.3 | 23 | 95 |
| 4.2 | 18 | 74 |
| 4.1 | 14 | 56 |
| 4.0 | 11 | 41 |
| 3.9 | 8 | 29 |
| 3.8 | 6 | 20 |
| 3.7 | 4 | 13 |
| 3.6 | 3 | 9 |
| 3.5 | 2 | 5 |
| 3.4 | 1 | 3 |
| 3.3 | — | 1.5 |
| 3.2 | — | 0.75 |
| 3.1 | — | 0.37 |
| 3.0 | — | — |

Table 1 and FIG. 3 experimentally represent the electrical current flowing in the organic light emitting diode and the brightness when the voltage of the first power supply ELVDD is gradually dropped in a 2.1 inch panel of a display device.

Referring to Table 1 and FIG. 3, voltage controller 70 incrementally supplies level signals LS to first power supply generating unit 60 over seventeen times. In this case, the first power supply generating unit 60 reduces the amplitude of the voltage of the first power supply ELVDD by 0.1 V increments whenever a level signal LS is received. Meanwhile, level signals LS may be set as the same signal or different signals whenever they are supplied. For example, level signals LS may be set as either seventeen different signals or alternatively, as data having seventeen different bits, etc.,

If the voltage of the first power supply ELVDD drops by 0.1 V, the current IEL flowing in the organic light emitting diode is reduced. If the current flowing IEL in the organic light emitting diode is reduced, brightness L of the corresponding pixel 40 is gradually reduced, too.

In other words, when the pixel unit 40 displays black, the present invention gradually reduces the voltage of the first power supply ELVDD incrementally at least two, or more times, thereby smoothly switching the brightness of the screen of the display device.

The foregoing paragraphs describe as one embodiment of the principles of the present invention, a circuit and process capable of smoothly switching between screens of an organic light emitting display by switching an image of a pixel unit that includes a matrix of pixels into a black image by sequentially reducing the voltage of a first power supply at least two times to display the black image as the screen of the pixel unit transitions to the black image. With this implementation, the organic light emitting diode and the driving method therefor as practiced according to the principles of the present invention, when a black image is to be displayed on a pixel unit, the potential difference between ELVDD and ELVSS applied across the organic light emitting diodes of the pixel units is decrementally reduced from a first value of voltage to a second value of voltage, in correspondence with level signals LS over an interval of time, thereby enabling a smooth transition to the black image presented by the screen of the display device.

While the present invention has been described in connection with certain exemplary embodiments, it is to be understood that the invention is not limited to the disclosed embodiment, but, on the contrary, is intended to cover various modifications and equivalent arrangements included within the spirit and scope of the appended claims, and equivalents thereof.

What is claimed is:

1. A driving method of an organic light emitting display including pixels controlling the amount of current flowing from a first power supply to a second power supply via an organic light emitting diode, the method including the steps of:
switching an image of a pixel unit including the pixels into a black image; and
sequentially dropping voltage of the first power supply at least two times to display the black image when being switched into the black image.

2. The driving method of the organic light emitting display as claimed in claim 1, wherein the step switching into the black image includes switching into a sleep mode and turning off power, since input is not made for a predetermined time.

3. An organic light emitting display including:
a pixel unit positioned in an intersection part of scan lines and data lines, and including pixels controlling the amount of current flowing from a first power supply to a second power supply via an organic light diode;
a timing controller generating screen switching signals when an image displayed on the pixel unit is switched into a black image;
a voltage controller sequentially generating a plurality of level signals when the screen switching signals are input; and
a first power supply generating unit sequentially dropping the voltage of the first power supply whenever the level signals are input.

4. The organic light emitting display as claimed in claim 3, wherein the timing controller generates the screen switching signals in the cases of a sleep mode and turning off power, since input from the external is not made for a predetermined time.

5. The organic light emitting display as claimed in claim 3, wherein the first power supply generating unit drops the voltage of the first power supply until a black image is displayed on the pixel unit.

6. The organic light emitting display as claimed in claim 3, further including a scan driver for supplying scan signals to the scan lines; and a data driver for supplying data signals to the data lines.

7. A method for driving an organic light emitting display device, comprising the steps of:
in an organic light emitting display device comprised of an array of pixels, controlling the amount of current flowing from a first power supply terminal to a second power supply terminal via an organic light emitting diode; and
switching a pixel unit including the pixels to present a black image by sequentially reducing voltage at the first power supply terminal at least twice.

8. The method of claim 7, comprised of making a determination of whether signals representing images have been received during a predetermined period of time, and when the determination established that signals representing images have been not been received during the predetermined period of time, performing the step of switching the pixel unit to present the black image.

9. The method of the claim 7, comprised of placing the display device in a sleep mode by performing the step of switching the pixel unit to present the black image.

10. The method of the claim 7, comprised of responding an interruption of electrical power to the display device by performing the step of switching the pixel unit to present the black image.
